(19) United States
(12) Patent Application Publication
(10) Pub. No.: US 2025/0116822 A1
(43) Pub. Date: Apr. 10, 2025

(54) Safety Plug

(71) Applicant: Amphenol Socapex, Thyez Cedex (FR)

(72) Inventors: Steven FALCOZ, Thyez Cedex (FR); Matthieu RINSANT, Thyez Cedex (FR); Nicolas MEURICE, Thyez Cedex (FR); Christophe BERNARDI, Thyez Cedex (FR)

(21) Appl. No.: 18/905,934

(22) Filed: Oct. 3, 2024

(30) Foreign Application Priority Data
Oct. 4, 2023 (FR) 2310570

(51) Int. Cl. G02B 6/38; H01R 13/447

(52) U.S. Cl. CPC G02B 6/3807; H01R 13/447

(57) ABSTRACT

The invention relates to a safety plug (1), comprising a plug body (10), a cap (20), and a locking screw (30). The plug body (10) has a thread around a central axis (X) for cooperating with a complementary thread, and a tapped opening (14), eccentric relative to the central axis (X). The cap (20) is mounted on the plug body (10) and has a through opening (24), eccentric relative to the central axis (X) so as to be able to be aligned with the tapped opening (14) of the plug body (10) by rotation around the central axis (X), of the cap (20) relative to the plug body (10). The locking screw (30) is able to be partially screwed and unscrewed, in the tapped opening (14) of the plug body (10), between a protruding position in which an outer end (31) of the locking screw (30) penetrates into the through opening (24) of the cap (20) to secure the cap (20) to the plug body (10), and a recessed position in which the locking screw (30) does not reach the through opening (24) of the cap (20), the cap (20) then being free in rotation, around the central axis (X), relative to the plug body (10).

Figure for the abstract: FIG. 2.

### TECHNICAL FIELD

The present description relates to the technical field of safety plugs, intended to prevent accidental or malicious opening, and in particular but not exclusively malicious access to electrical or optical connectors intended for the transmission of data.

### PRIOR ART

Safety plugs of different types have been proposed for a wide range of applications, particularly the packaging of medicines or toxic products, but also the safety of circuits such as for example gas circuits or data transmission circuits.

Certain safety plugs, such as those disclosed in patents U.S. Pat. No. 4,775,061 and FR 2 763 316, and in the patent application publication US 2021/0247013 A1, comprise a plug body with a thread around a central axis for cooperating with a complementary thread, and a cap mounted on the plug body, mounted free in rotation around the central axis. In these safety plugs, as the cap hides the body of the plug and does not allow transmitting an unscrewing movement to the plug body, the plug can be opened only by a special tool gaining access to a complementary pattern on the body of the plug through a central through opening in the cap. However, the security offered by these safety plugs, in particular when dealing with malicious access, remains limited, because the central through opening in the cap allows easy observation of the pattern on the body of the plug, and it is then sufficient to obtain a tool adapted to this pattern to open the plug.

In other similar safety plugs, a specific manipulation can secure the cap to the plug body in rotation around the central axis, to allow the unscrewing of the plug by turning the cap. Thus, in the safety plug disclosed in patent EP 0 528 561 B1, an axial movement of the cap relative to the plug body allows securing them in rotation around the central axis. However, the security offered by this plug also remains limited. In the safety plug disclosed in the publication of the international patent application WO 89/07076, a keyed lock allows securing the cap in rotation to the plug body. This solution, however, has the disadvantage of relative mechanical complexity, while still having a certain vulnerability to malicious access because the lock remains directly accessible from the outside. Finally, in the series of safety plugs marketed by the Polamco Ltd. company under reference PRC433TL, a grub screw received in a tapped opening passing through the cap, and eccentric relative to the central axis, can be tightened until it exerts a pressure on the surface of the plug body, so as to secure the cap by friction with the plug body. However, this solution has the disadvantage that the pattern of the grub screw still remains always directly accessible from the outside, which limits protection against malicious access.

### DISCLOSURE OF THE INVENTION

The present description seeks to disclose a safety plug offering better protection against malicious access, while remaining mechanically simple.

For this purpose, according to a first aspect, this safety plug can comprise a plug body, a cap and a locking screw. The plug body can have a thread around a central axis for cooperating with a complementary thread, and a tapped opening, eccentric relative to the central axis. The cap can be mounted on the plug body and have a through opening, eccentric relative to the central axis so as to be able to be aligned with the tapped opening of the plug body in rotation, around the central axis, of the cap relative to the plug body. The locking screw can be able to be partially screwed and unscrewed, in the tapped opening of the plug body, between a protruding position in which an outer end of the locking screw penetrates into the through opening of the cap to secure the cap to the plug body, and a recessed position in which the locking screw does not reach the through opening of the cap, the cap then being free in rotation around the central axis, relative to the plug body.

If, in the recessed position of the locking screw, the cap is free in rotation relative to the plug body, its through opening can cease to be aligned with the locking screw, which will thus no longer be accessible from the outside. A person seeking to gain access to the locking screw to partially unscrew it, and thus secure the cap to the plug body in rotation around the central axis, will then first have to turn the cap so as to realign its through opening with the locking screw, even before being able to gain access to it. This operation, requiring additional time and knowledge, and therefore difficult to execute in a concealed manner, represents an additional obstacle to malicious access.

In order to prevent the locking screw from passing entirely through the through opening of the cap, an outer diameter of the locking screw, in particular an outer diameter of the thread of the locking screw can be greater than an inner diameter of the through opening of the cap. Thus, the locking screw will not be able to be extracted from the safety plug and will remain captive in it, thus preventing its loss as well as possible damage that a loose locking screw could cause in certain applications, particularly aeronautical or military.

The locking screw can also have a non-standard pattern, thus requiring a special tool for screwing and unscrewing it, which will also represent an additional obstacle to malicious access, the more so since, as the screw is not directly accessible or even visible before its alignment with the through opening of the cap, a person seeking to open the plug surreptitiously will normally not know the shape of this pattern nor the tool adapted to it before having previously aligned the through opening with the screw.

The tapped opening of the plug body, the locking screw and the through opening of the cap can in particular be substantially parallel to the central axis. Thus, the through opening of the cap can open onto a front face of the cap, facilitating the actuation of the locking screw by an authorized person equipped with the appropriate tool once it is aligned with the through opening. However, it is alternatively contemplatable that the tapped opening of the plug body, the locking screw and the through opening of the cap are inclined, even perpendicular relative to the central axis, and that the through opening then opens onto a lateral surface of the cap.

The threading of the plug body around the central axis can be a tapped thread, i.e. an internal thread. Thus, the plug body can be screwed onto a baseplate with a complementary external thread, covering it. However, it can also be contemplated that the threading of the plug body is external, so that the plug body can be screwed into a baseplate with a complementary internal thread. In this case, the tapped wall of the baseplate could be received between the plug body and the cap, in such a manner that the cap also covers the baseplate.

The cap can also comprise an attachment point aligned with the central axis, for example to attach it to the baseplate by means of a chain or lanyard to avoid the loss of the plug after its opening.

A second aspect relates to an assembly which can comprise the safety plug according to the first aspect mentioned above, and a baseplate with the thread complementary to the thread around the central axis of the plug body. This assembly can in particular also comprise at least one electrical or optical connector inside the baseplate. Thus, the safety plug can serve to prevent malicious access to this connector, particularly for data piracy.

A third aspect relates to a method for opening the safety plug according to the first aspect mentioned above, this method being able to comprise steps of rotating the cap around the central axis of the plug body until the through opening of the cap is aligned with the tapped opening of the plug body and the locking screw, partial unscrewing of the locking screw from the recessed position to the protruding position for securing the cap to the plug body, and unscrewing of the safety plug by rotation of the cap secured to the plug body.

A fourth aspect relates to a method for securing the safety plug according to the first aspect mentioned above, comprising a step of screwing the locking screw from the protruding position to the recessed position for disengaging the cap from the plug body in rotation around the central axis, as well as possibly also the rotation of the cap around the central axis of the plug body to misalign the through opening of the cap relative to the tapped opening of the plug body and the locking screw.

### BRIEF DESCRIPTION OF THE DRAWINGS

The invention will be well understood and its advantages will appear more clearly upon reading the detailed description that follows, of embodiments shown by way of non-limiting examples. The description refers to the appended drawings, which are schematic and aim primarily to illustrate the principles of the disclosure.

In these drawings, from one figure to another, identical or equivalent elements (or parts of elements) are labeled with the same reference symbols. On these appended drawings:

FIG. 1 is a perspective view of a safety plug according to a first embodiment.

FIG. 2 is an axial section of the safety plug of FIG. 1, in the plane II-II, on a baseplate with a data transmission connector.

FIG. 3 is a detail view of the locking screw in the protruding position.

FIG. 4 is a schematic axial section of a safety plug according to a second embodiment, with an external thread, screwed into a baseplate.

FIG. 5 is a schematic axial section of a safety plug according to a third embodiment, with a radially oriented locking screw.

### DESCRIPTION OF THE EMBODIMENTS

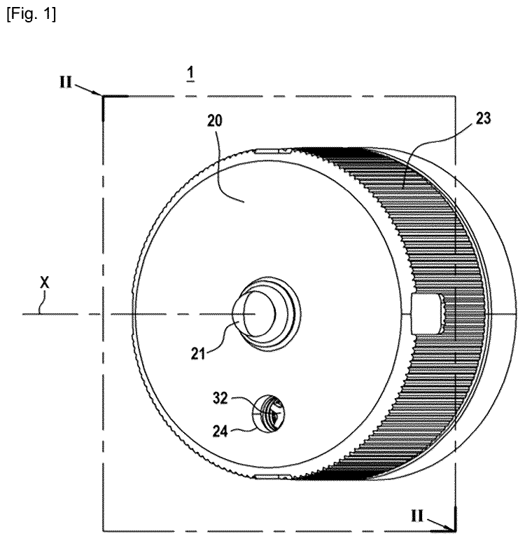

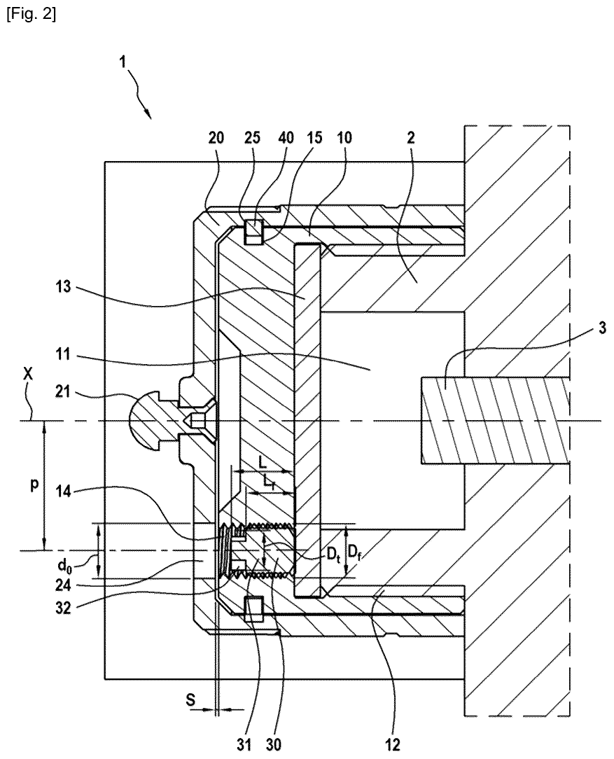

As illustrated in FIGS. 1 and 2, a safety plug 1 according to a first embodiment can comprise a plug body 10, a cap 20 and a locking screw 30. The plug body 10 can be intended to be screwed onto a baseplate 2 in order to prevent access to it. This baseplate 2 can for example receive an electrical connector 3, such as for example an RJ45 or USB connector, and/or an optical connector able to transmit data. Thus, the safety plug 1 can allow securing this connector against a malicious connection, intended for example to extract confidential data without authorization, or to introduce falsified data or malicious software.

To allow the screwing of the plug body 10 to the baseplate, the plug body 10 can comprise a cavity 11 open toward a rear face of the plug body 10, with a tapped internal surface 12, i.e. having an internal thread around a central axis X of the plug body 10, for cooperating with a complementary external thread 21 on the baseplate 2. A flexible disk 13, of polysiloxane for example, intended for form a hermetic seal against the baseplate 2, can be arranged on the bottom of the cavity 11. The plug body 10 can also include a tapped opening 14, eccentric relative to the central axis X. As illustrated in FIG. 2, this tapped opening 14 can be parallel to the central axis X and open onto a front face of the plug body 10, opposite to its rear face in the direction of the central axis X.

The cap 20 can be mounted in rotation around the central axis X on the plug body 10, but with zero or restrained axial displacement in the direction of the central axis X, so as to avoid its separation from the plug body 10. The plug body 10 and the cap 20 can for example be coupled axially by an elastic washer 40 received in complementary annular grooves 15, 25 in respectively an outer surface of the plug body 10 and an inner surface of the cap 20. The cap 20 can cover the plug body 10 except on its outer face, in order to prevent access to the plug body 10 once it is screwed to the baseplate 2. The cap 20 can in particular include an attachment point 21 for a link (not illustrated), such as a chain or lanyard, intended to hold the safety plug 1 attached to the baseplate 2 even when it is open, and thus avoid its accidental loss. This attachment point 21 can for example take the form of a stud retained in rotation in a through opening of the cap 20. The outer surface of the cap 20 can have a non-skid treatment 23, such as for example straight or criss-cross knurling, to facilitate its gripping, particularly for turning the cap 20 around the central axis X. The cap 20 can also have a through opening 24, eccentric relative to the central axis X and arranged so as to be able to be aligned with the tapped opening 14 of the plug body 10 by rotation of the cap 20 relative to the plug body 10 around the central axis X. Thus, in the example illustrated in FIGS. 1 and 2, the through opening 24 can also be parallel to the central axis X and arranged at the same radial distance r from the central axis X as the tapped opening 14 of the plug body 10.

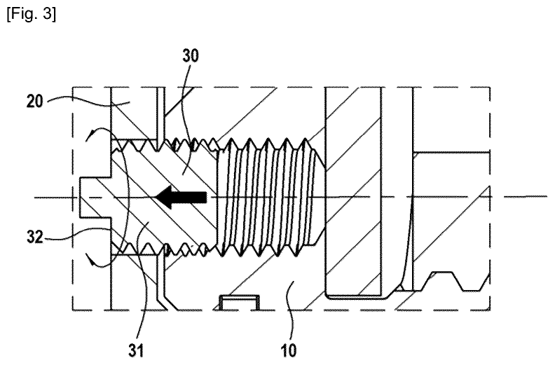

The locking screw 30 can have a thread complementary to that of the tapped opening 14 of the plug body 10 so as to be able to be screwed into the tapped opening 14. An outer end 31 of the locking screw 30 can have an outer diameter Dt less than the inner diameter dₒ of the through opening 24 of the cap 20, so that this outer end 31 of the locking screw 30 can be inserted with limited clearance into the through opening 24 of the cap 20, while the locking screw 30 can have a total length L and a threaded length L_{f}, such that the locking screw 30 is able to be partially screwed and unscrewed in the tapped opening 14, between a protruding position, illustrated in FIG. 3, in which the outer end 31 of the locking screw 30 penetrates into the through opening 24 of the cap 20 to secure the cap 20 to the plug body 10 in rotation around the central axis X, and a recessed position, illustrated in FIG. 2, in which the locking screw 30 does not reach the through opening 24 of the cap 20, the cap 20 then being disengaged in rotation around the central axis X relative to the plug body 10. On the other hand, the thread of the locking screw 30 can have an outer diameter Dt greater than the inner diameter do of the through opening 24 of the cap 20, so that the locking screw 30 is unable to pass entirely through the through opening 24 of the cap 20, and therefore remains captive in the safety plug. The threaded length L_{f} of the locking screw 30 can moreover be greater than the distance S separating the through opening 24 from the tapped opening 14 in the direction of the threading axis of the locking screw 30.

In order to allow the at least partial screwing and unscrewing of the locking screw 30, it can have, on its outer end 31, a pattern 32 able to be engaged by a suitable tool to turn the locking screw 30 around its central threading axis. This pattern 32 can in particular be a non-standard pattern, so that the locking screw 30 cannot be actuated with currently commercialized tools.

The plug body 10, the cap 20, and the locking screw 30 can be of a metallic material, for example aluminum or an aluminum-based alloy, bronze or stainless steel. However, non-metallic materials, and particularly organic polymers, can also be contemplated. In the event that aluminum or an aluminum alloy is used, it could receive a surface treatment, for example based on zinc-nickel, cadmium or tin-zinc. In the event that stainless steel is used, it could for example be plain, passivated or nickel-plated.

For closing the safety plug 1, the locking screw 30 can initially be in the protruding position, thus securing the cap 20 and the plug body 10, as illustrated in FIG. 3. The plug body 10 can then be screwed onto the baseplate 2 by turning the cap 20 around the central axis X. After having screwed the plug body 10, with the cap 20, onto the baseplate 2, until the flexible ring 13 is tightened against the base 2, the safety plug 1 can be secured by screwing the locking screw 30 into its recessed position, as illustrated in FIG. 2, so as to disengage the cap 20 from the plug body 10 in rotation around the central axis X. In this recessed position of the locking screw 30, the rotation of the cap around the central axis X not only will not serve in any way to unscrew the plug body 10 from the base 2, but will also displace the through opening 24 of the cap 20 out of alignment with the tapped opening 14 and the locking screw 30, thus hiding the latter.

For opening the safety plug 1 thus secured, the cap 20 can first of all be turned around the central axis X of the plug body 10, until the through orifice 24 of the cap 20 is aligned with the tapped opening 14 of the plug body 10 and the locking screw 30. The locking screw 30, the pattern 32 of which has thus been made accessible through the through opening 24, can then be partially unscrewed, with an appropriate tool, from the recessed position to the protruding position to secure the cap 20 to the plug body 10. The safety plug 1 can then be unscrewed, by rotation of the cap 20 secured to the plug body 10, to open it and thus make the baseplate 2 accessible.

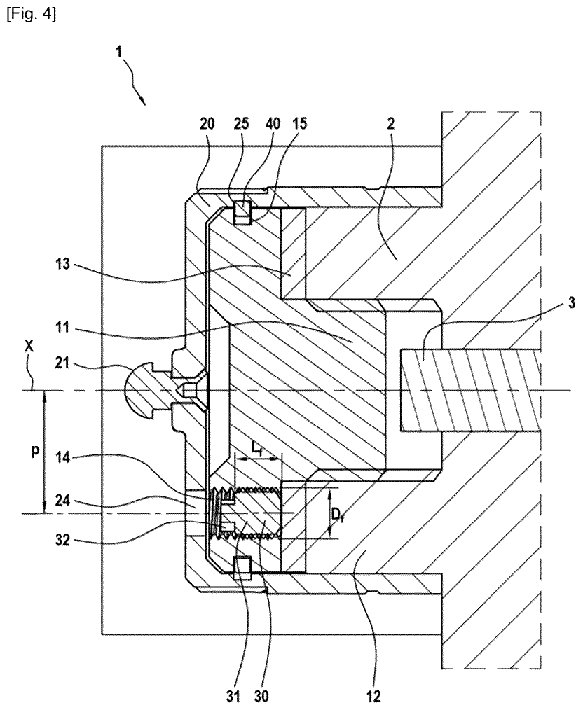

Although in the embodiment illustrated in FIGS. 1 to 3, the thread of the plug body 10 around the central axis X is a tapped thread, i.e. an internal thread, it is alternatively contemplatable that this thread is an external thread, as in the alternative embodiment illustrated in FIG. 4. In a safety plug 1 according to this second embodiment, the plug body 10 can comprise a threaded external surface 12′ around the central axis X, so as to allow the screwing of the plug body 10 into a baseplate 2 with a complementary internal thread. The cap 20 can be formed so as to cover the plug body 10 and the baseplate 2. The remaining elements of the safety plug 1 of FIG. 4 are identical or similar to those of the safety plug 1 of FIGS. 1 to 3, and consequently receive the same reference symbols.

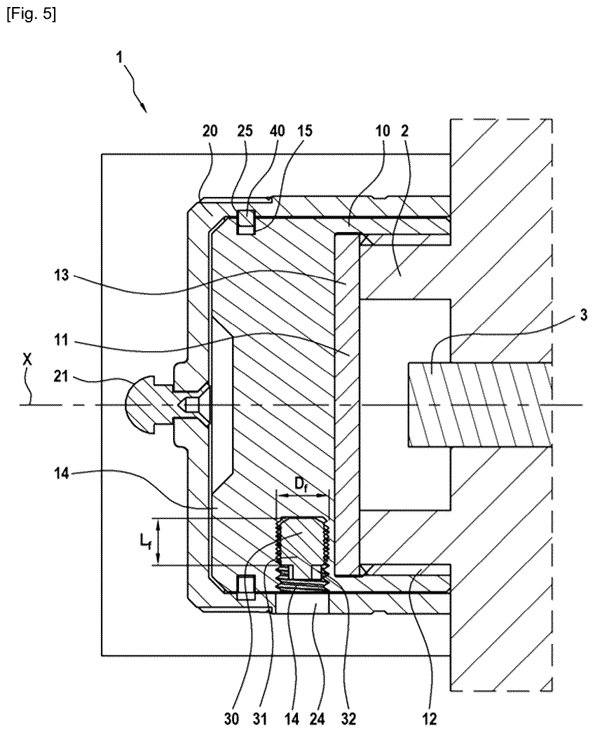

Although, in the preceding embodiments, the tapped opening 14 of the plug body 10, the through opening 24 of the cap 20, and the locking screw 30 are parallel to the central axis X, it is alternatively contemplatable that they are inclined relative to the central axis X, even perpendicular to it as illustrated in FIG. 5. Thus, in this third embodiment, the tapped opening 14 of the plug body 10, the through opening 24 of the cap 20, and the locking screw can be oriented radially relative to the central axis X, the tapped opening 14 and the through opening 24 then opening onto respective lateral surfaces of the plug body 10 and of the cap 20. The remaining elements of the safety plug 1 of FIG. 5 are identical or similar to those of the safety plug 1 of FIGS. 1 to 3, and consequently receive the same reference symbols.

Although the present invention has been described by referring to specific exemplary embodiments, it is obvious that different modifications and changes can be performed on these examples without departing from the general scope of the invention as defined by the claims. In addition, individual features of the different embodiments mentioned can be combined into additional embodiments. Consequently, the description and the drawings must be considered in an illustrative, rather than a restrictive sense.

1. A safety plug, comprising:
a plug body, with a thread around a central axis for cooperating with a complementary thread, and having a tapped opening, eccentric relative to the central axis,
a cap mounted on the plug body and having a through opening, eccentric relative to the central axis, so as to be able to be aligned with the tapped opening of the plug body by rotation around the central axis, of the cap relative to the plug body, and
a locking screw, able to be partially screwed and unscrewed, in the tapped opening of the plug body, between a protruding position in which an outer end of the locking screw penetrates into the through opening of the cap to secure the cap to the plug body, and a recessed position in which the locking screw does not reach the through opening of the cap, the cap then being free in rotation around the central axis, relative to the plug body.

2. The safety plug according to claim 1, wherein an outer diameter of the locking screw is greater than an inner diameter of the through opening of the cap.

3. The safety plug according to claim 2, wherein the outer diameter of the locking screw, greater than the inner diameter of the through opening of the cap, is an outer diameter of the thread of the locking screw.

4. The safety plug according to claim 1, wherein the locking screw has a non-standard pattern.

5. The safety plug according to claim 1, wherein the tapped opening of the plug body, the locking screw and the through opening of the cap are substantially parallel to the central axis.

6. The safety plug according to claim 1, wherein the thread of the plug body around the central axis is an internal thread.

7. The safety plug according to claim 1, wherein the cap also comprises an attachment point aligned with the central axis.

8. An assembly comprising the safety plug according to claim 1, and a baseplate with the thread complementary to the thread of the plug body around the central axis.

9. The assembly according to claim 8, also comprising at least one electrical or optical connector inside the baseplate.

10. A method for opening the safety plug according to claim 1, comprising the following steps:
rotating the cap around the central axis of the plug body, until the through opening of the cap is aligned with the tapped opening of the plug body and the locking screw,
partial unscrewing of the locking screw from the recessed position to the protruding position to secure the cap to the plug body, and unscrewing the safety plug by rotation of the cap secured to the plug body.

11. A method of securing the safety plug according to claim 1, comprising a step of screwing the locking screw from the protruding position to the recessed position for disengaging the cap from the plug body.
